(19) United States
(12) Patent Application Publication
(10) Pub. No.: US 2026/0220244 A1
(43) Pub. Date: Jul. 30, 2026

(54) METHODS AND DEVICES FOR PREREGISTERED PARALLEL FIDO KEYS FOR ISSUER AUTHENTICATION

(71) Applicant: Capital One Services, LLC, McLean, VA (US)

(72) Inventors: Kevin Osborn, Newton Highlands, MA (US); Bob Uni Koshy, Henrico, VA (US)

(21) Appl. No.: 19/041,755

(22) Filed: Jan. 30, 2025

(51) Int. Cl. G06F 21/34

(52) U.S. Cl. CPC G06F 21/34; G06F 2221/034

(57) ABSTRACT

The disclosed methods and devices are directed to pre-registering Fast Identity Online (FIDO) security keys on contactless cards for providing security in transactions and web resource access. A user attempts to log in to their account on an application, and instead of using their normal password, a FIDO key is used. In some cases, the FIDO key is pre-registered on a contactless card associated with the user and the user taps their card to their mobile device to log in to the application using FIDO. An authentication server sends a FIDO challenge to the card, which signs a FIDO response to the FIDO challenge. A FIDO public key associated with the user account is used by the authentication server to verify the signed FIDO response. The user is logged in if the FIDO response is verified. The FIDO key is pre-registered on the card at personalization.

### FIELD OF THE DISCLOSURE

The present disclosure is generally related to authentication systems, and more specifically to implementations of preregistered parallel Fast Identity Online (FIDO) keys for issuer authentication.

### BACKGROUND

Public key challenge authentication protocols such as FIDO2 by the FIDO Alliance and/or passkeys are reliable in producing unforgeable authentications that may be facilitated using security keys stored on a user device. The security keys are randomly generated and used in a FIDO authentication process to sign a FIDO challenge when accessing an online resource using FIDO-based security. However, the association of such authentication credentials (e.g., the FIDO signature, provided by a user device) to a trusted user identity, is generally based on user-provided identification credentials (e.g., username, password, government-issued identification) provided during the FIDO registration process.

In FIDO-based systems, a user will register with the authentication system (e.g., via a website) to log into their account. The user will not need to remember a password because the FIDO framework requires the user device creating the account to have a FIDO private key as well as a FIDO public key associated therewith. During the FIDO registration process, the authentication system will create an account for the new user device being registered and associate the FIDO public key from the user device with the user account being registered. One deficiency of the current FIDO scheme is that the user device requires a separate registration and FIDO private key for each account the user device registers an account with. As a result, memory onboard user devices with limited storage space is utilized very quickly. In addition, separate registration processes can be cumbersome, time-consuming, and vulnerable to fraud.

These and other deficiencies exist. As such, there is need for an improved system and process for a secure and accessible determination of trust in a source device and/or a user initiating a FIDO registration request.

### BRIEF SUMMARY

One general aspect of the present disclosure includes a method for preregistered parallel FIDO keys for issuer authentication. In some embodiments, the method includes receiving an access request at a computing device, the access request being associated with a user account associated with a contactless card. In response to receiving the access request, the method further includes sending, by the computing device, a Fast Identity Online (FIDO) challenge to the contactless card. The method further includes signing, by the contactless card, a FIDO response to the FIDO challenge with encrypted data, the encrypted data being derived from a FIDO secret key stored on memory of the contactless card. The method further includes sending, by the contactless card, the FIDO response with the encrypted data to the computing device for processing. The method further includes determining, by the computing device, whether the encrypted data corresponds to expected data for the user account. In response to the computing device determining that the encrypted data corresponds to the expected data, the method further includes granting, by the computing device, the access request from the user account associated with the contactless card.

Another general aspect of the present disclosure includes a contactless card comprising a memory to store executable instructions thereon and a processing circuit to execute the executable instructions. When the instructions are executed by the processing circuit, the processing circuit is caused to send an access request to an authentication server, the access request being associated with a user account associated with the contactless card. The processing circuit is further caused to receive, from the authentication server, a FIDO challenge, sign a FIDO response to the FIDO challenge with encrypted data, the encrypted data being derived from a FIDO secret key stored on the memory of the contactless card. The processing circuit is further caused to send the FIDO response with the encrypted data to the authentication server for processing. The processing circuit is further caused to receive an indication that the authentication server has determined that the encrypted data correspond to expected data for the user account. In response to receiving the indication, the processing circuit is further caused to process the access request with an application server in communication with the contactless card.

Another general aspect of the present disclosure includes an authentication server comprising a memory to store executable instructions thereon and a processing circuit to execute the instructions. When the instructions are executed by the processing circuit, the processing circuit is caused to receive an access request from a transaction server in communication with a contactless card associated with a user account, where the authentication server is also in communication with the contactless card. In response to receiving the access request, the processing circuit is further to send a FIDO challenge to the contactless card. The processing circuit is further to receive, from the contactless card, a FIDO response to the FIDO challenge, the FIDO response being signed by the contactless card with encrypted data derived from a FIDO secret key stored on memory of the contactless card. The processing circuit is further to determine whether the encrypted data corresponds to expected data for the user account. In response the encrypted data corresponding to the expected data, the processing circuit is further to grant the access request from the user account associated with the contactless card.

Non-transitory computer program products (e.g., physically embodied computer program products) are also described that store instructions, which, when executed by one or more data processors (e.g., processor circuit) of one or more computing systems, cause at least one data processor to perform operations herein. Similarly, computer systems are also described, which may include one or more data processors and memory coupled to the one or more data processors. The memory may temporarily or permanently store instructions that cause at least one processor to perform one or more of the operations described herein. In addition, methods can be implemented by one or more data processors, which are either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE SEVERAL VIEWS OF THE DRAWINGS

Provided below is a brief description of the several views of the drawings which illustrate various aspects of some embodiments of the present disclosure. The various drawings are described in more detail in the Detailed Description that follows. To easily identify the discussion of any particular element or act, the most significant digit or digits in a reference number refer to the figure number in which that element is first introduced.

FIG. 1 illustrates a connection network in accordance with one embodiment.

FIG. 2 illustrates a flow diagram in accordance with one embodiment.

FIG. 3A illustrates an example personalization process in accordance with one embodiment.

FIG. 3B illustrates another example of a personalization process in accordance with one embodiment.

FIG. 4 illustrates a connection network in accordance with one embodiment.

FIG. 5 is a diagram illustrating an example contactless card in accordance with one embodiment.

FIG. 6 is a block diagram illustrating various components of the contactless card in accordance with one embodiment.

FIG. 7 illustrates a method in accordance with one embodiment.

FIG. 8 illustrates an example system in accordance with one embodiment.

FIG. 9A illustrates a flow diagram in accordance with one embodiment.

FIG. 9B illustrates a flow diagram in accordance with one embodiment.

FIG. 9C illustrates a flow diagram in accordance with one embodiment.

FIG. 10 illustrates a message format in accordance with one embodiment.

FIG. 11 is a topology diagram of an example network in accordance with one embodiment.

### DETAILED DESCRIPTION

The following description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Furthermore, the described features, advantages, and characteristics of the exemplary embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments. One skilled in the relevant art will understand that the described features, advantages, and characteristics of any embodiment can be interchangeably combined with the features, advantages, and characteristics of any other embodiment.

Described herein are example solutions to the above deficiencies of the existing security landscape. Namely, the subject matter of the present disclosure deals with pre-registering a contactless card associated with a user account with a FIDO private key. The user account is pre-registered with an application server that hosts the user account. The FIDO private key is pre-registered at personalization of the contactless card and stored or saved in memory on the contactless card. As such, when trying to access or otherwise log in to the user account associated with the contactless card, the contactless card skips the FIDO registration process because the user account and FIDO private key are already pre-registered, and goes straight into responding to a FIDO challenge from the authentication server associated with the application server. This improves upon the current FIDO and security landscape by reducing processing on the part of the contactless card, and improves on login and access times.

In addition to reducing login and access times, the example embodiments provided herein also preserve memory storage on the contactless card. For example, in a traditional FIDO security scheme, the contactless card (or any other suitable hardware that responds to FIDO challenges and is registered with the FIDO authentication server) would register a separate FIDO private key for each user account the contactless card is to be used for. In an embodiment where a user uses FIDO security to login to their bank account and another account, for example, a travel website that is a partner of their bank, the user would have to register a user account with separate FIDO private keys with both the bank and the travel website. If enough of these user accounts with FIDO private key pairs are generated and stored on the contactless card, the memory utilization of the contactless card would quickly reach a maximum utilization.

Further, by reducing the number of separate registrations, the example embodiments provided herein can increase the security of registration, user identifications, and transactions. Less registrations can reduce the opportunities for comprised credentials, identity theft, or other forms of fraud.

As described below, embodiments of the present disclosure minimize memory utilization, and therefore improve upon existing systems by only registering one FIDO private key on the contactless card, at personalization, and using a shared authorization server between the different user accounts to complete the FIDO verification process. Other application servers having accounts with the user associated with the contactless card are in communication with the shared authorization server and trust verification results thereof. As such, only one FIDO private key and registration is needed, and memory utilization on the contactless card is minimized.

Other variations on this general description are also contemplated. In some instances, contactless card functions discussed herein may be utilized in a multi-issuer computing environment. These functions may include tap-to functions where a user may tap their contactless card on a device, such as a contactless card reader or a mobile device, to perform a function, such as responding to a FIDO challenge.

The systems and methods described herein may enable users to perform these functions in a multi-issuer environment. Further, the systems discussed herein enable card issuers or payment providers, such as a banks, to issue contactless cards with tap-to functions to customers while maintaining a high-level security. The systems discussed differ from previous solutions because they provide a single platform for multiple issuers to provide the tap-to functionality for FIDO and other security processing. Traditionally, each issuer must set up and maintain their own systems to provide contactless card features. This includes maintaining their own hardware, software, databases, security protocols, and so forth, which can become extremely costly for the issuer to maintain. However, embodiments discussed herein enable issuers to offload much of the processing, storage, and security functionality to a neutral or central system. As will be discussed in more detail, the central system is configured to provide contactless card features for multiple issuers while maintaining a high level of security and data integrity. Each issuer's functionality and data may be separately managed and secured such that another issuer cannot access another issuer's data or functions. As will be discussed in more detail, these features may be provided by a switchboard system (also referred to herein as a routing network) that is configured to process and perform each contactless card function in a secure manner. Additional benefits for issuers may include providing a highly secure authentication option for mobile web, which typically lack the robust authentication options available in a native application.

Further, embodiments discussed herein support tap-to mobile web experiences on both major mobile platforms (iOS®, Android®) by leveraging App Clips® and JavaScript® Software Development Kit (SDK) with WebNFC®. For iOS®, embodiments include providing a tap-to software development kit including functions and services to perform the operations discussed herein on the iOS® platform. The SDK may be installed into the host application, e.g., a native app or web browser app, and includes App Clip® support. The SDK provides functional support for near-field communication between the mobile device and contactless card, installing a native app via App Clips®, and functionality to obscure data and/or portions of a display. In one example, the SDK may be configured to download and install the app from an app store, such as Apples® App Store.

In the Android® operating system environment, embodiments include utilizing a JavaScript SDK. The JavaScript SDK may be installed into a website, e.g., via website source code. The JavaScript SDK also includes functions to support NFC communications between the mobile device contactless card via WebNFC®. The JavaScript SDK may also include functions to provide customizable user interface (UI) capabilities and obfuscation. In embodiments, the JavaScript SDK supports websites utilizing Hypertext Transfer Protocol Secure (HTTPS) and supports the React® library. Embodiments are not limited in this manner and UIs libraries may be supported.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

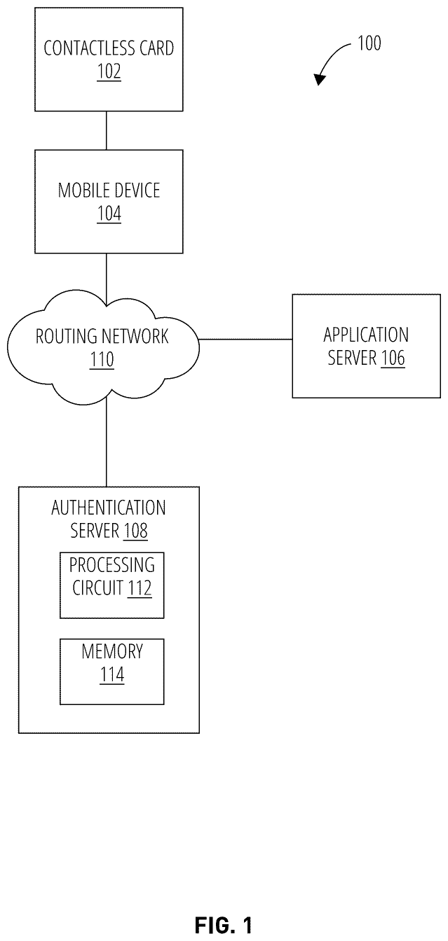

FIG. 1 illustrates a connection network 100 between a mobile device 104, an authentication server 108, and an application server 106. Although the figure depicts a mobile device 104, any suitable computing device is contemplated by the present disclosure. For the purposes of the present disclosure, the mobile device 104 can be a smart phone, mobile phone, tablet computer, personal computer, cell phone, personal data assistant (PDA), or any other suitable device. The mobile device 104 can include a network connection via routing network 110 or any other suitable network such as a local area network (LAN), mobile communications network (e.g., 2G, 3G, 4G, LTE, 5G, 6G, etc.), wide area network (WAN), wireless LAN (WLAN), or any other suitable network that connects the mobile device 104 to the application server 106 and the authentication server 108. The application server 106 hosts an application for which a user of the mobile device 104 wishes to access or login to. For example, the application server 106 can host a mobile banking application (e.g., credit card account application) and the user of the mobile device 104 has a user account associated therewith.

The user account executes a mobile application on the mobile device 104 and attempts to login to the banking application that is hosted on the application server 106. The application server 106 receives the login request and communicates with the authentication server 108 to authenticate the user account associated with the mobile device 104 into which the user is attempting to login. As discussed in further detail herein, the authentication server 108, which includes a processing circuit 112 and memory 114 to perform operations described herein, communicates with the contactless card 102 via the mobile device 104 to verify the user account attempting to login to the application server 106. Once the authentication server 108 verifies or authenticates the user account, the authentication server 108 sends a message to the application server 106 indicating that the user account has been validated or authenticated and thereby, the user is permitted by the application server 106 to access services of the application server 106, including the banking application.

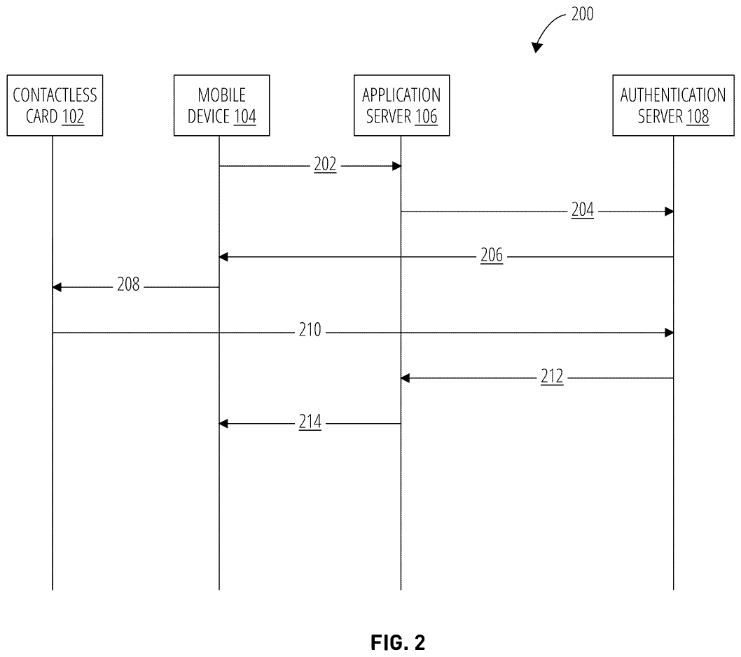

FIG. 2 includes a flow diagram 200 that illustrates an example authorization process for authorizing the user account to access the banking application or other application operating on the application server 106. The login attempt by the user, using the mobile device 104 is not by using the typical “username” and “password” combination. Instead, embodiments of the present disclosure are related to password-less FIDO authentication. As known by those having ordinary skill in the art, FIDO does not require the user to remember a password, and instead uses a separate passkey to provide login credentials. In some instances, FIDO authentication implements multi-factor authentication in a single user-friendly step, whereby the user scans their fingerprint or performs facial recognition on their phone, or they might insert a hardware kay (e.g., on a flash drive) to login to their account. Embodiments of the present disclosure use a contactless card to perform the FIDO authorization step. Namely, when attempting to login to the account on the application server 106, the mobile device 104 prompts the user to tap their contactless card 102 to the mobile device 104, and the FIDO authentication steps discussed below are exchanged between the contactless card 102 and the authentication server 108 via the mobile device 104. The contactless card 102 communicates authorization information to the mobile device 104 via near field communication (NFC), BlueTooth®, Wi-Fi, radio-frequency identification (RFID), or any other suitable protocol. In instances where the mobile device 104 is actually a personal computer, a laptop, or any other computing device that does not have native NFC or RFID communication possible, the computing device may be equipped with an NFC or RFID reader and the FIDO communications can be passed from the contactless card 102 to the computing device via the NFC/RFID reader.

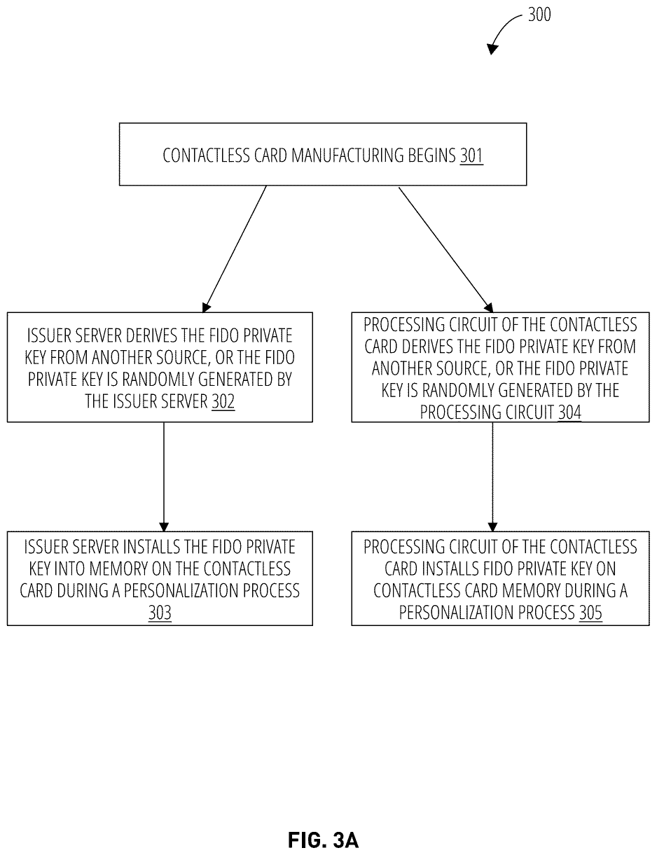

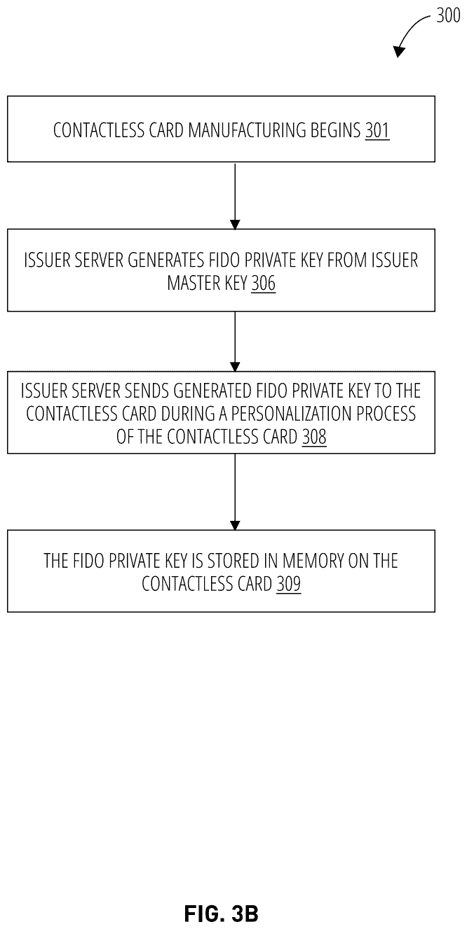

In some embodiments of the present disclosure, during manufacture and personalization of the contactless card 102, the user account associated with the contactless card can be pre-registered with the application server 106 and the authentication server 108 and a FIDO private key can be assigned to contactless card 102 and stored in the memory of the contactless card 102. At personalization, a FIDO public key, which is used to decode signed FIDO responses from the contactless card 102, is shared with the authentication server 108 and any other suitable server that may need to authorize the contactless card 102 in a FIDO security process. The FIDO private key can be randomly generated or it can be derived from another source. FIG. 3A and FIG. 3B below illustrate example processes for generating the FIDO private key. The FIDO public key is associated with the user account associated with the FIDO private key. That is, the contactless card 102 has stored thereon the FIDO private key and the contactless card 102 and the FIDO private key are associated with the user account of the user (e.g., owner of the contactless card 102). Additionally, the contactless card 102 includes an applet operating thereon for FIDO authentication to complete the FIDO process steps discussed herein. The contactless card 102 and the user account are pre-registered for FIDO with the authentication server 108 and the FIDO public key for the user account of the contactless card 102 is associated with the user account and saved to the authentication server 108 and the user account is also registered with the application server 106.

As shown in FIG. 2, once the contactless card 102 has been personalized with the FIDO secret key and the user account associated with the contactless card 102 has been pre-registered with the authentication server 108 with the FIDO public key and the user account pre-registered with the application server 106, the user attempts to login to the application server 106. At flow 202, the mobile device 104 sends a login request (also referred to as an access request) to the application server 106 to login to the application operating on the login server (e.g., the bank or credit card application for the contactless card 102). The application server 106 then sends the login request to the authentication server 108 at flow 204. The login request includes the user account information for the user account, and since the user account is already pre-registered with the authentication server 108, the authentication server 108 knows the FIDO public key.

As discussed above with respect to FIG. 1, the authentication server 108 can include a memory 114 to store executable instructions thereon and a processing circuit memory 114 to execute the instructions. When the instructions are executed, the processing circuit 112 is caused to receive the login or access request from application server 106 (also referred to herein as a transaction server), which is in communication with contactless card 102 associated with the user account. As shown in FIGS. 1 and 2, the the authentication server 108 is also in communication with the contactless card 102. In response to receiving the login request, or access request, at flow 206, the authentication server 108 is to send a FIDO challenge to the mobile device 104. The mobile device 104 is to prompt the user to tap their contactless card 102 to the mobile device 104 to forward the FIDO challenge to the contactless card 102 via NFC, RFID or any other suitable method. Once the contactless card 102 is brought within proximity to the mobile device 104, the mobile device 104 forwards the FIDO challenge to the contactless card 102. As discussed above, the contactless card 102 includes an applet operating thereon for FIDO authentication. In some embodiments, the applet processes the FIDO challenge and signs a FIDO response by manipulating the FIDO challenge to encipher the FIDO challenge using the FIDO private key stored on the applet (or memory of the contactless card 102) at personalization. In other words, the FIDO response is signed by the contactless card 102 with encrypted data (the enciphered FIDO challenge that was signed into the FIDO response) derived from the FIDO secret key stored on the memory of the contactless card.

At flow 210, the manipulated or enciphered FIDO challenge (e.g., encrypted data) is then sent as a FIDO response to the FIDO challenge back to the authentication server 108. The authentication server 108 is then to receive, from the contactless card 102, the FIDO response to the FIDO challenge. The authentication server 108 processes the FIDO response to determine whether the encrypted data in the FIDO response corresponds to expected data for the user account. In some embodiments, the authentication server 108 uses the FIDO public key associated with the user account associated with the contactless card 102 to decrypt the encrypted data in the FIDO response. When the authentication server 108 generated the FIDO challenge, it did so using the FIDO public key associated with the user account. As such, the authentication server 108 would know what the FIDO response should be and therefore has expected data for which it expects the decrypted FIDO response (that was decrypted using the FIDO public key) to correspond. In some embodiments, to evaluate the decrypted data, the processing circuit 112 is further to compare the decrypted data to the expected data to determine if the encrypted data (as decrypted) corresponds to the expected data.

At flow 212, in response to the encrypted data corresponding to the expected data, the processing circuit 112 of the authentication server 108 is to send instructions to the application server 106, that initially received the access request to access features of the application server 106, to grant the access request from the user account associated with the contactless card 102. That is, the authentication server 108 is to send a message to the application server 106 indicating that the user account is authorized to access the account on the banking application operating on the application server 106 based on the encrypted data corresponding to the expected data. At flow 214, the application server 106 then sends a message to the mobile device 104 granting access to the features of the banking application.

Although not shown in FIG. 2, in some embodiments, instead of the authentication server 108 receiving the FIDO public key, the processing circuit 112 of the authentication server 108 is further to receive, from a server of an issuer of the contactless card, the FIDO public key associated with the user account and the contactless card 102.

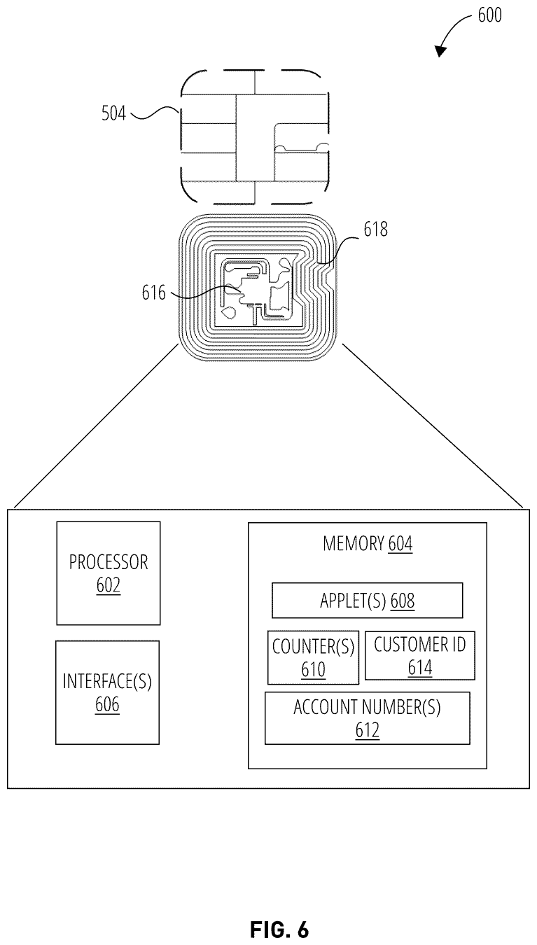

FIG. 3A illustrates an example personalization process 300 for the contactless card 102 above, whereby the FIDO private key is personalized onto the contactless card 102 during a personalization process (e.g., at card manufacturing). As discussed, the FIDO private key can be randomly generated or it can be derived from another source. FIG. 3A illustrates alternative processes whereby an issuer personalization server or the processing circuit of the card itself generates the FIDO private key. In either branch, the personalization process 300 begins at block 301 whereby the contactless card manufacturing process begins. This is also referred to the personalization process where various permanent features are manufactured into the card. In addition to the unique card account number(s) 612 described below in FIG. 6, certain security features may also be included in the card at the personalization process 300.

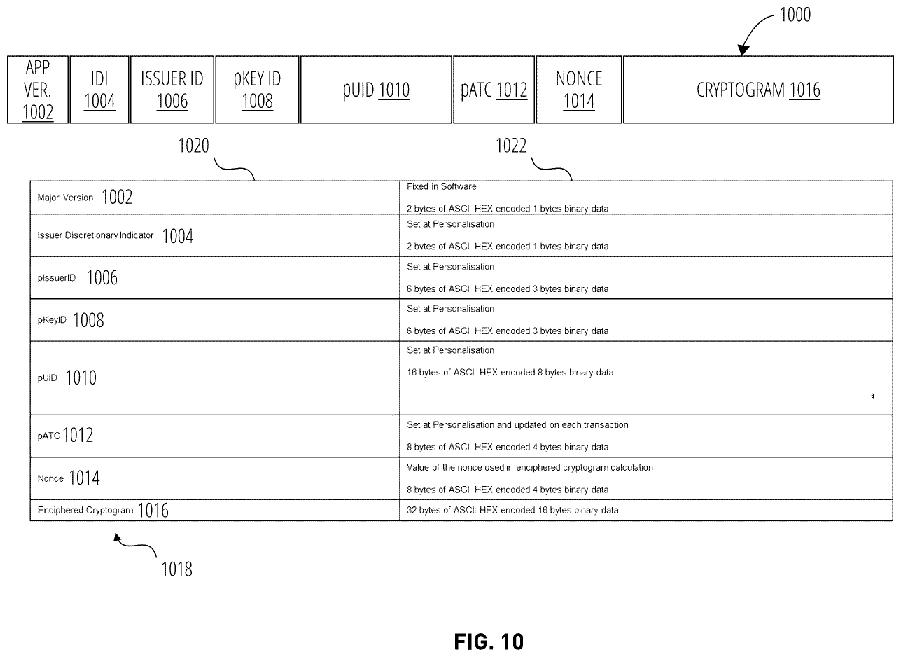

In some embodiments, at block 302, the card issuer server (e.g., a server that issues instructions for manufacturing the cards issued by the issuer) may derive the FIDO private key from another source. For example, the FIDO private key may be derived from a Key Derivation Key (e.g., FKA master key) through a key derivation algorithm using encrypted data from the contactless card. For example, the contactless card 102 can send a message similar to message 1000 described in FIG. 10 below, and the key derivation algorithm can use the pUID 1010 from the message 1000 to generate the Key Derivation Key. Alternatively, the issuer server may randomly generate the FIDO private key using a random number generator or any other suitable generator that can produce random or pseudo-random numbers.

At block 303, the issuer server then sends the derived FIDO private key or the random number FIDO private key to contactless card 102 and installs the FIDO private key into permanent memory storage on the contactless card 102 during the personalization process.

In some embodiments, as shown at block 304, a processing circuit of the contactless card 102 is configured to derive the FIDO private key from another source. For example, the processing circuit of the contactless card 102 can derive the FIDO private key from a unique derived card key (UDK) stored on the contactless card 102. In this example, the contactless card 102 would generate a hierarchical key based on the UDK and use the hierarchical key as the FIDO private key. As another example, the processing circuit of the contactless card 102 can be configured to randomly generate the FIDO private key using a random number generator or any other suitable generator that can produce a random or pseudo-random numbers.

At block 305, the processing circuit of the contactless card 102 installs the FIDO private key that was derived or randomly generated into permanent memory storage on the contactless card 102 during the personalization process.

FIG. 3B illustrates another example personalization process 300 for the contactless card 102 above, whereby the FIDO private key is derived using a master key from the issuer, and the FIDO private key is personalized on the contactless card 102 during the personalized process.

Similar to FIG. 3A, the personalization process 300 starts at block 301, whereby the contactless card manufacturing process begins. At block 306, the issuer server generates the FIDO private key from the issuer master key. The issuer master key is a master key from which all keys and secret keys are derived.

Once the issuer server generates the FIDO private key from the issuer master key, at block 308, it is sent to the contactless card 102 during a personalization process of the block 308. The FIDO private key is then stored in memory on the contactless card at block 309. The FIDO private key is stored in non-volatile memory so that the FIDO private key can remain in memory permanently.

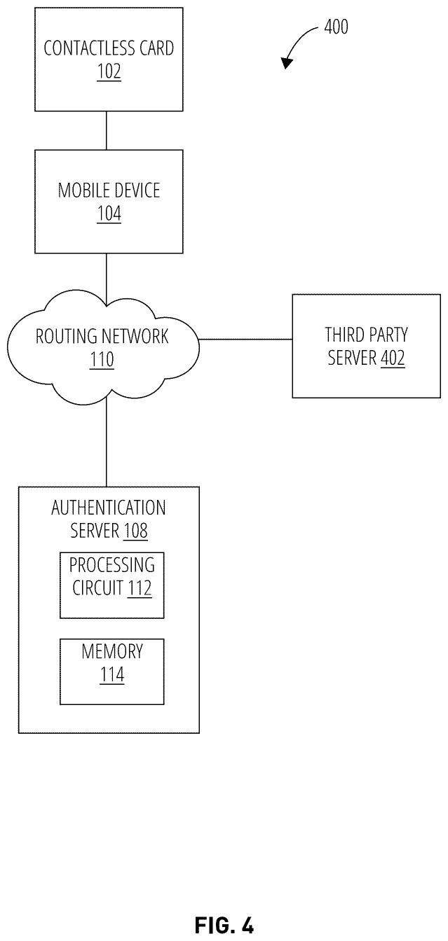

FIG. 4 illustrates a similar connection network 400 to FIG. 1, however, in this embodiment, the application server 106 is replaced with a third party server 402. In this example, the third party server 402 can be controlled by a third party that is, for example, a partner of the bank or issuer of the credit card company that manufactured or personalized the contactless card 102. For example, the third party server 402 may be controlled by a travel partner of the issuer of the contactless card 102. The travel partner may have a travel application operating on the third party server 402 that the user account attempts to access via the mobile device 104. Similar operations as discussed above are completed to authorize access. However, in this case the third party server 402 trusts authorization decisions made by the authentication server 108 although the authentication server 108 and the third party server 402 may not be a part of the same company or organization. However, the authentication server 108 and the third party server 402 can communicate with each other over the routing network 110 and the authentication server 108 can provide its authentication result to the third party server 402.

In this example embodiment, the user account associated with the mobile device 104 which is attempting to access the account on the third party server 402 sends a login request to the third party server 402, and indicates that the user account is also registered with the authentication server 108. The third party server 402 forwards the login or access request to the authentication server 108 for processing because the third party server 402 trusts the decisions of the authentication server 108. From here, the operations remain the same in that the authentication server 108 sends the FIDO challenge to the mobile device 104 which forwards it to the contactless card 102 and the applet on the contactless card 102 signs the FIDO response to the challenge. The authentication server 108 receives the FIDO response from the contactless card 102 and then decrypts the FIDO response using the FIDO public key for the user account.

If the decrypted FIDO response corresponds to expected decrypted data for the user account, the authentication server 108 sends a message to the third party server 402 indicating that the user account is authorized to login or access systems on the third party server 402. For example, the user account may access a travel account operating on the third party server 402 or any other system operating thereon.

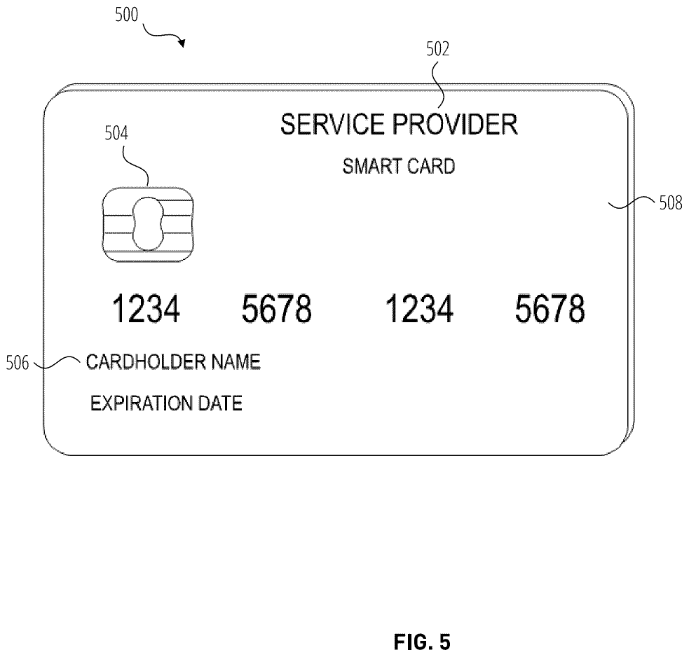

FIG. 5 illustrates an example configuration of a contactless card 500, which may include a contactless card, a payment card, such as a credit card, debit card, or gift card, issued by a service provider as displayed as a service provider indicia 502 on the front or back of the contactless card 500. In some cases, contactless card 102 can be embodied using contactless card 500. In some examples, the contactless card 500 is not related to a payment card, and may include, without limitation, an identification card. In some examples, the transaction card may include a dual interface contactless payment card, a rewards card, and so forth. The contactless card 500 may include a substrate 508, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 500 may have physical characteristics compliant with the ID-1 format of the ISO/IEC 7816 standard, and the transaction card may otherwise be compliant with the ISO/IEC 14443 standard. However, it is understood that the contactless card 500 according to the present disclosure may have different characteristics, and the present disclosure does not require a transaction card to be implemented in a payment card.

The contactless card 500 may also include identification information 506 displayed on the front and/or back of the card, and a contact pad 504. The contact pad 504 may include one or more pads and be configured to establish contact with another client device, such as an ATM, a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 500 may also include processing circuitry, antenna and other components as will be further discussed in FIG. 6. These components may be located behind the contact pad 504 or elsewhere on the substrate 508, e.g. within a different layer of the substrate 508, and may electrically and physically coupled with the contact pad 504. The contactless card 500 may also include a magnetic strip or tape, which may be located on the back of the card (not shown in FIG. 5). The contactless card 500 may also include a Near-Field Communication (NFC) device coupled with an antenna capable of communicating via the NFC protocol. For example, the NFC device can be used by the contactless card 500 to communicate with a mobile device such as mobile device 104 from FIG. 1. Embodiments are not limited in this manner.

FIG. 6 illustrates various circuitry that a transaction card component 600 of the contactless card 500 includes. As illustrated in FIG. 6, the contact pad 504 of contactless card 500 may include processing circuitry 616 for storing, processing, and communicating information, including a processor 602, a memory 604, and one or more interface(s) 606. It is understood that the processing circuitry 616 may contain additional components, including processors, memories, error and parity/CRC checkers, data encoders, anticollision algorithms, controllers, command decoders, security primitives and tamperproofing hardware, as necessary to perform the functions described herein.

In some embodiments, the memory 604 includes executable instructions stored thereon which are executable by the processing circuitry 616. The memory 604 may be a read-only memory, write-once read-multiple memory or read/write memory, e.g., RAM, ROM, and EEPROM, and the contactless card 500 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 604 may be encrypted memory utilizing an encryption algorithm executed by the processor 602 to encrypt data.

The memory 604 may be configured to store one or more applet(s) 608, one or more counter(s) 610, a customer identifier 614, and the account number(s) 612, which may be virtual account number(s) 612 numbers. The one or more applet(s) 608 may comprise one or more software applications configured to execute on one or more contactless cards, such as a Java® Card applet. However, it is understood that applet(s) 608 are not limited to Java Card applets, and instead may be any software application operable on contactless cards or other devices having limited memory. The one or more counter(s) 610 may comprise a numeric counter sufficient to store an integer. The customer identifier 614 may comprise a unique alphanumeric identifier assigned to a user of the contactless card 500, and the identifier may distinguish the user of the contactless card from other contactless card users. In some examples, the customer identifier 614 may identify both a customer and an account assigned to that customer and may further identify the contactless card 500 associated with the customer's account. As stated, the account number(s) 612 may include thousands of one-time use virtual account numbers associated with the contactless card 500. An applet(s) 608 of the contactless card 500 may be configured to manage the account number(s) 612 (e.g., to select an account number(s) 612, mark the selected account number(s) 612 as used, and transmit the account number(s) 612 to a mobile device for autofilling by an autofilling service.

The processor 602 and memory 604 elements of the foregoing exemplary embodiments are described with reference to the contact pad 504, but the present disclosure is not limited thereto. It is understood that these elements may be implemented outside of the contact pad 504 or entirely separate from it, or as further elements in addition to processor 602 and memory 604 elements located within the contact pad 504.

In some examples, the contactless card 500 may comprise one or more antenna(s) 618. The one or more antenna(s) 618 may be placed within the contactless card 500 and around the processing circuitry 616 of the contact pad 504. For example, the one or more antenna(s) 618 may be integral with the processing circuitry 616 and the one or more antenna(s) 618 may be used with an external booster coil. As another example, the one or more antenna(s) 618 may be external to the contact pad 504 and the processing circuitry 616.

In an embodiment, the coil of contactless card 500 may act as the secondary of an air core transformer. The terminal may communicate with the contactless card 500 by cutting power or amplitude modulation. The contactless card 500 may infer the data transmitted from the terminal using the gaps in the contactless card's power connection, which may be functionally maintained through one or more capacitors. The contactless card 500 may communicate back by switching a load on the contactless card's coil or load modulation. Load modulation may be detected in the terminal's coil through interference. More generally, using the antenna(s) 618, processor 602, and/or the memory 604, the contactless card 500 provides a communications interface to communicate via NFC, Bluetooth, and/or Wi-Fi communications.

As explained above, contactless card 500 may be built on a software platform operable on smart cards or other devices having limited memory, such as JavaCard, and one or more or more applications or applets may be securely executed. Applet(s) 608 may be added to contactless cards to provide a one-time password (OTP) for multifactor authentication (MFA) in various mobile application-based use cases. Applet(s) 608 may be configured to respond to one or more requests, such as near field data exchange requests, from a reader, such as a mobile NFC reader (e.g., of a mobile device or point-of-sale terminal), and produce an NDEF message that comprises a cryptographically secure OTP encoded as an NDEF text tag.

One example of an NDEF OTP is an NDEF short-record layout (SR=1). In such an example, one or more applet(s) 608 may be configured to encode the OTP as an NDEF type 4 well known type text tag. In some examples, NDEF messages may comprise one or more records. The applet(s) 608 may be configured to add one or more static tag records in addition to the OTP record.

In some examples, the one or more applet(s) 608 may be configured to emulate an RFID tag. The RFID tag may include one or more polymorphic tags. In some examples, each time the tag is read, different cryptographic data is presented that may indicate the authenticity of the contactless card. Based on the one or more applet(s) 608, an NFC read of the tag may be processed, the data may be transmitted to a server, such as a server of a banking system, and the data may be validated at the server.

In some examples, the contactless card 500 and authentication server 108 from FIG. 1 may include certain data such that the card may be properly identified. The contactless card 500 may include one or more unique identifiers (not pictured). Each time a read operation takes place, the counter(s) 610 may be configured to increment. In some examples, each time data from the contactless card 500 is read (e.g., by a mobile device), the counter(s) 610 is transmitted to the authentication server 108 for validation and determines whether the counter(s) 610 are equal (as part of the validation) to a counter of the authentication server 108.

The one or more counter(s) 610 may be configured to prevent a replay attack. For example, if a cryptogram has been obtained and replayed, that cryptogram is immediately rejected if the counter(s) 610 has been read or used or otherwise passed over. If the counter(s) 610 has not been used, it may be replayed. In some examples, the counter that is incremented on the card is different from the counter that is incremented for transactions. The contactless card 101 is unable to determine the application transaction counter(s) 610 since there is no communication between applet(s) 608 on the contactless card 500.

In some examples, the counter(s) 610 may get out of sync. In some examples, to account for accidental reads that initiate transactions, such as reading at an angle, the counter(s) 610 may increment but the application does not process the counter(s) 610. In some examples, when the NFC reader of the mobile device 104 is woken up, NFC may be enabled and the NFC reader of the mobile device 104 may be configured to read available tags, but no action is taken responsive to the reads.

To keep the counter(s) 610 in sync, an application, such as a background application, may be executed that would be configured to detect when the NFC reader of the mobile device 104 wakes up and synchronize with the server of a banking system indicating that a read that occurred due to detection to then move the counter(s) 610 forward. In other examples, Hashed One Time Password may be utilized such that a window of mis-synchronization may be accepted. For example, if within a threshold of 10, the counter(s) 610 may be configured to move forward. But if within a different threshold number, for example within 10 or 1000, a request for performing re-synchronization may be processed which requests via one or more applications that the user tap, gesture, or otherwise indicate one or more times via the user's device. If the counter(s) 610 increases in the appropriate sequence, then it is possible to know that the user has done so.

The key diversification technique described herein with reference to the counter(s) 610, master key, and diversified key, is one example of encryption and/or decryption a key diversification technique. This example key diversification technique should not be considered limiting of the disclosure, as the disclosure is equally applicable to other types of key diversification techniques.

During the creation process of the contactless card 500, two cryptographic keys may be assigned uniquely per card. The cryptographic keys may comprise symmetric keys which may be used in both encryption and decryption of data. Triple DES (3DES) algorithm may be used by EMV and it is implemented by hardware in the contactless card 500. By using the key diversification process, one or more keys may be derived from a master key based upon uniquely identifiable information for each entity that requires a key. In some examples, the two cryptographic keys may be derived from two master keys and then the two cryptographic keys may be stored on the card.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 500 is used in operation, a different key may be used for creating the message authentication code (MAC) and for performing the encryption. This results in a triple layer of cryptography. The session keys may be generated by the one or more applets and derived by using the application transaction counter with one or more algorithms.

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The encrypted data may be delivered as the content of a text NDEF record in hexadecimal ASCII format. In another example, the NDEF record may be encoded in base-ten ASCII format.

Alternatively or in addition to the above description, in some embodiments of the present disclosure, the applet(s) 608 can include a FIDO authentication applet installed at personalization of the card. The FIDO authentication applet can include the FIDO private key stored in memory 604 at personalization (e.g., card manufacturing). In addition to being configured to send out encrypted data, such as the OTP discussed above, the processor 602, through execution of the FIDO authentication applet, is configured to respond to respond to FIDO challenges and process other FIDO messages.

The FIDO private key is added to the contactless card 500 at personalization using a session key. More specifically, at personalization, a personalization server of the card issuer has a key encryption key installed thereon. Then the personalization server creates a session key for the contactless card 500 using transcription from the key encryption key to the session key. The personalization server communicates with the FIDO authentication applet on the contactless card 500 and sends the session key to the contactless card 500. The contactless card 500 can then decrypt the session key to obtain the FIDO private key and store the FIDO private key in its memory 604, such as in a secure memory space.

Additionally, the user account for the contactless card 500 can be associated with the FIDO public key retained when the FIDO registration process for the contactless card 500 occurs at personalization. For example, an enterprise identifier (enterprise ID) can be assigned to the contactless card 500 at personalization along with the FIDO private key. The enterprise ID can be retained by the issuer personalization server and shared with, for example, the authentication server to associate the contactless card 500 and the user account thereof with the FIDO public key retained by the personalization and authentication servers. In some cases, when the authentication server attempts to authenticate the user account using the FIDO challenge and responses, the authentication server may require an additional level of security. In this example embodiment, the authentication server requests the enterprise ID from the contactless card 500 in addition to the FIDO response signature and an encrypted version of the enterprise ID is sent by the contactless card 500 to the authentication server along with the FIDO response as a form of enterprise attestation, which represents a higher level of security for the process discussed herein. This additional layer of security may also improve authentication speed (e.g., make authentication faster). Namely, instead of the authentication server reviewing user accounts for the decrypted FIDO response, the authentication server can look up user accounts by the enterprise ID included in the FIDO response, and find the user account using the enterprise ID potentially faster than the FIDO response. Finding the user account quickly in a database, using the enterprise ID, allows the authentication server to more quickly compare the expected data for the FIDO response signature to the data stored in the database for the user account entry.

In another alternative embodiment, instead of the FIDO secret key being created by the issuer and installed on the contactless card 500 at personalization, in some embodiments, the contactless card 500 includes the FIDO authenticator application and the FIDO secret key being derived by the FIDO authenticator application as described above in FIG. 3A and FIG. 3B.

The following description is an example authorization process whereby the FIDO secret key is stored on the memory 604 of the contactless card 500 at personalization. Initially, the processor 602 of the contactless card 500 may be configured to send an access request to an authentication server, the access request being associated with the user account associated with the contactless card. For example, instead of the embodiment above where the mobile device 104 initiates the user account login to the application server 106, the contactless card 102 can be tapped to the mobile device 104 to initiate the user account login process. In this case, the processor 602 would send the access request message to the application server 106 instead of the mobile device 104 sending the access request. This is a variation on how the user account login can occur.

Next, in the example embodiment, the processor 602 is to receive, from the authentication server, FIDO challenge. The processor 602 processes the FIDO challenge as discussed above and then is to sign a FIDO response to the FIDO challenge with encrypted data, the encrypted data being derived from the FIDO secret key stored on the memory 604 of the contactless card 500. As discussed above, to sign the FIDO response, the FIDO challenge is enciphered using the FIDO private key stored on the memory 604. The processor 602 is then to send the FIDO response with the encrypted data (e.g., signed using the FIDO private key) to the authentication server for processing.

Once the authentication server validates the FIDO response using the FIDO public key for the user account associated with the contactless card 500, the processor 602 of the contactless card 500 is to receive an indication that the authentication server has determined that the encrypted data corresponds to expected data for the user account. Then, in response to receiving the indication, the processor 602 is to process the access request with an application server in communication with the contactless card 500.

In some cases, the processor 602 may send a second access request, associated with the user account, to the authentication server. The processor 602 then will receive, from the authentication server, a second FIDO challenge corresponding to the second access request, and the processor 602 will derive second encrypted data from an altered version of the FIDO secret key, the second encrypted data being different than the encrypted data. For example, the processor 602 may derive a second “signature” to sign a second FIDO response. In some embodiments, the processor 602 may use the counter(s) 610, in addition to the FIDO private key, to derive the second signature to sign the second FIDO response. The processor 602 is then to sign the second FIDO response to the second FIDO challenge with the second encrypted data and send the second FIDO response with the second encrypted data to the authentication server for processing.

The processor 602 will then receive a second indication that the authentication server has determined that the second encrypted data corresponds to altered expected data that is altered based on the altered version of the FIDO secret key. In response to receiving the second indication, the processor 602 of the contactless card 500 will process the second access request with the application server in communication with the contactless card.

At block 702, method 700 includes receiving an access request at a computing device (e.g., the authentication server), the access request being associated with a user account associated with a contactless card. At block 704, in response to receiving the access request, the method 700 includes sending, by the computing device, FIDO challenge to the contactless card. At block 706, method 700 includes signing, by the contactless card, a FIDO response to the FIDO challenge with encrypted data, the encrypted data being derived from a FIDO secret key stored on memory of the contactless card. At block 708, method 700 includes sending, by the contactless card, the FIDO response with the encrypted data to the computing device for processing. At block 710, method 700 includes determining, by the computing device, whether the encrypted data corresponds to expected data for the user account. At block 712, in response to the computing device determining that the encrypted data corresponds to the expected data, the method 700 includes granting, by the computing device, the access request from the user account associated with the contactless card.

In some embodiments, the access request includes at least one selected from the group of a request by the user to sign into the user account; a request by the user to sign into another user account; and a transaction request.

In some embodiments, the method 700 further comprises receiving the access request from the user account at a transaction server, or an application server, as the user account attempts to access features of the transaction server. In some embodiments, granting the access request by the computing device comprises the computing device sending the transaction server a message indicating that the user account is authorized to access the features of the transaction server based on the encrypted data corresponding to the expected data. In some embodiments, the method 700 further comprises personalizing a FIDO authenticator application on the contactless card with the FIDO secret key, wherein personalizing the FIDO authenticator application is performed during a contactless card personalization process. In an alternative embodiment, the FIDO secret key can be derived by the contactless card as described above in FIG. 3A and FIG. 3B. In another embodiment the FIDO secret key can be derived, by an issuer server that issued the contactless card 102, from a master key controlled by the issuer server and stored outside of the contactless card and only the derived key is to be stored in the contactless card memory.

In some embodiments, the computing device determining that the encrypted data corresponds to the expected data includes: the computing device decrypting the encrypted data to obtain decrypted data; and evaluating the decrypted data to ensure that it corresponds to the expected data.

In some embodiments, the method 700 further comprises associating a FIDO public key with the user account and the contactless card, wherein the FIDO public key is retained by a server associated with an issuer of the contactless card at the contactless card personalization process and transmitting the FIDO public key to the computing device.

In some embodiments, decrypting the encrypted data to obtain the decrypted data comprises the computing device using the FIDO public key to decrypt the encrypted data to obtain the decrypted data. In some embodiments, evaluating the decrypted data comprises comparing the decrypted data to the expected data, the expected data including or being derived from the FIDO secret key, to determine whether the decrypted data corresponds to the expected data. In response to the decrypted data corresponding to the expected data, the method 700 further comprises sending, by the computing device, instructions to another computing device that also received the access request to grant the access request from the user account associated with the contactless card.

In some embodiments, the computing device receives a second access request associated with the user account, and the method further comprises, in response to receiving the second access request, sending, by the computing device, a second FIDO challenge to the contactless card. The method 700 further comprises deriving, by the contactless card, second encrypted data from an altered version of the FIDO secret key, the second encrypted data being different than the encrypted data and signing, by the contactless card, a second FIDO response to the second FIDO challenge with the second encrypted data. The method 700 further comprises sending, by the contactless card, the second FIDO response with the second encrypted data to the computing device for processing. In response to the computing device determining that the second encrypted data corresponds to altered expected data that is altered based on the altered version of the FIDO secret key, the method further comprises granting, by the computing device, the second access request from the user account associated with the contactless card.

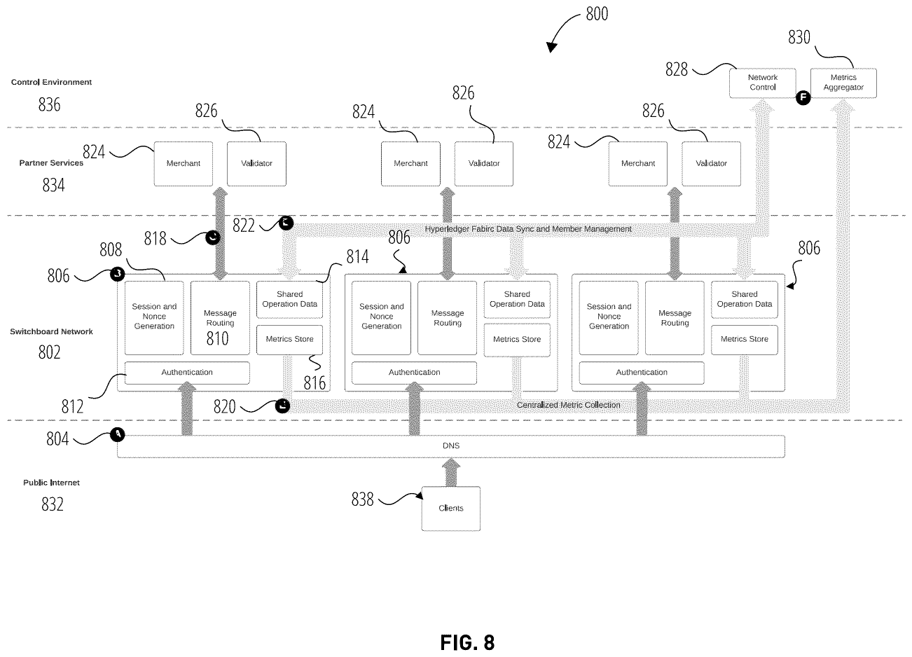

FIG. 8 illustrates an example of system 800 in accordance with embodiments discussed herein. The system 800 includes additional devices and systems configured to enable contactless card issuers to tap-to card services. Specifically, system 800 enables any number of issuer systems to provide card services to their clients through a switching fabric, i.e., the switchboard system 802 in a secure and safe manner. System 800 can be used as the routing network 110 discussed above with respect to FIG. 1 and FIG. 4. Although FIG. 8 illustrates the authorization messages being sent to a merchant system 824, this merchant system 824 can be replaced with the application server 106 or third party server 402 described herein. Namely, the FIDO challenge and response can be forwarded through the system 800 and sent to the merchant system 824, an application server 106, a third party server 402 or any other suitable system connected to the system 800.

In embodiments, the switchboard system 802 includes one or more nodes 806 configured to perform routing operations. Each node 806 may include a session and node generator 808, a message router 810, an authentication 812, an operation data 814 store, and a metrics store 816. Further, each of the nodes may be configured the same and share configurations, but each node 806 may independently process and route messages and requests to the appropriate systems, such as the merchant systems and issuer systems. Each of the nodes 806 is configured to act as a broker of trust between an issuer system, the merchant system 824, and/or validation system 826, for example. Each node 806 is configured to route each message to the correct issuer system while maintaining data security. For example, a node 806 may route a message between an issuer system and merchant system while the node is not able to gain access to the private data in the message.

The switchboard system 802 may be configured as server system including a collection of hardware, software, and networking components that work together to provide services to the clients. Hardware components may include one or more server computers, storage devices, and network adapters. The server computers are configured to run server applications, such as those executable on each of the nodes 806. In some instances, each of the server computers may be configured to operate one or nodes, e.g., in a virtual environment. The storage devices are configured to store data that is accessed by the applications and the network adapters are used to connect the server computer to the network.

Each of the server computers may be configured to execute software including the operating system, the applications, and security software. The networking components of a server system include the network switch, router, and firewall. The network switch is used to connect the server computers to other devices on the network. The router is used to route traffic between different networks. The firewall is used to protect the server system from unauthorized access and attacks.

In some embodiments, the nodes 806 may operate in a cloud-based computing environment, e.g., a collection of hardware, software, and networking components that enable the delivery of cloud computing services. The nodes node 806 and the computing services are delivered over the Internet, and they can be accessed from anywhere in the world with an Internet connection. In embodiments, a client SDK 838 may access a node 806 through Domain Name System 804 or domain name system (DNS). The DNS 804 The is a hierarchical and distributed naming system for computers, services, and other resources connected to the Internet or other networks. It associates various information with domain names assigned to each of the registered participants. In one example, the DNS 804 may translate a name known to software executing on a client 838 to route data to one or more of the node 806 of the switchboard system 802.

In embodiments, a client SDK 838 communicates with the switchboard system 802 to perform one or more of the partner services 834, such as conduct a transaction with a merchant, validate the customer, or other tap-to functions. Once the client SDK 838 identifies a node 806 and resolves an address to communicate with the node 806, the client SDK 838 may send one or more messages to the node 806 to authenticate and perform the operation. The node 806 includes an authentication 812 function that is configured to authenticate the client SDK 838. In embodiments, the client SDK 838 sends a message or authorization request to the node 806 with the following header set:
X-Sb-Api-Key: <CLIENT API KEY>
X-Sb-Dvc-Fngrprnt: Device-specific device fingerprint

The CLIENT API KEY may have the following example structure: 65535-GReyx5BuEAaE72bWbFZJfHRL8Dbt1Uum, where table 1 describes the value, name, and meaning:

TABLE 1

| Value | Name | Meaning |
|---|---|---|
| 65535 | Client | Individual |
| | ID | identifier of client |
| GReyx5BuEAaE72bWbFZJfHRL8Dbt1Uum | Client | Randomly |
| | Key | assigned key |

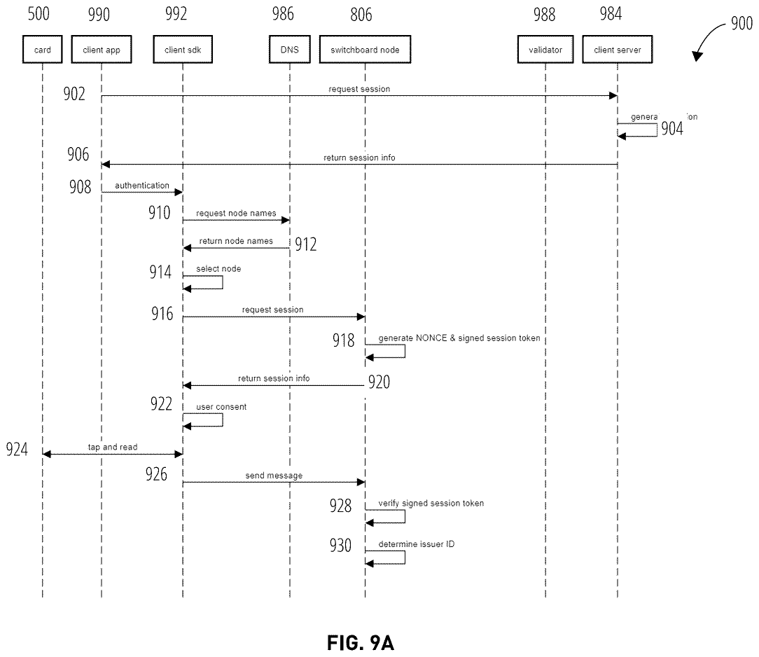

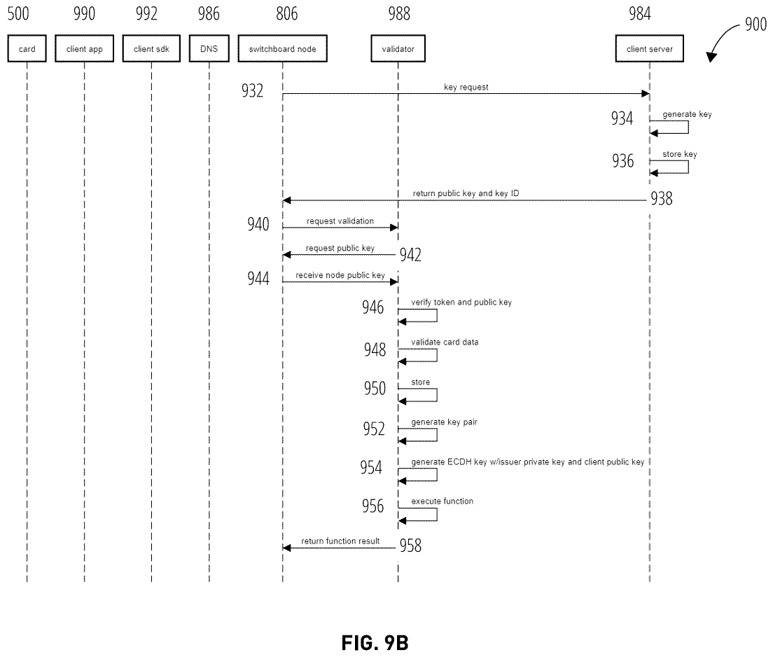

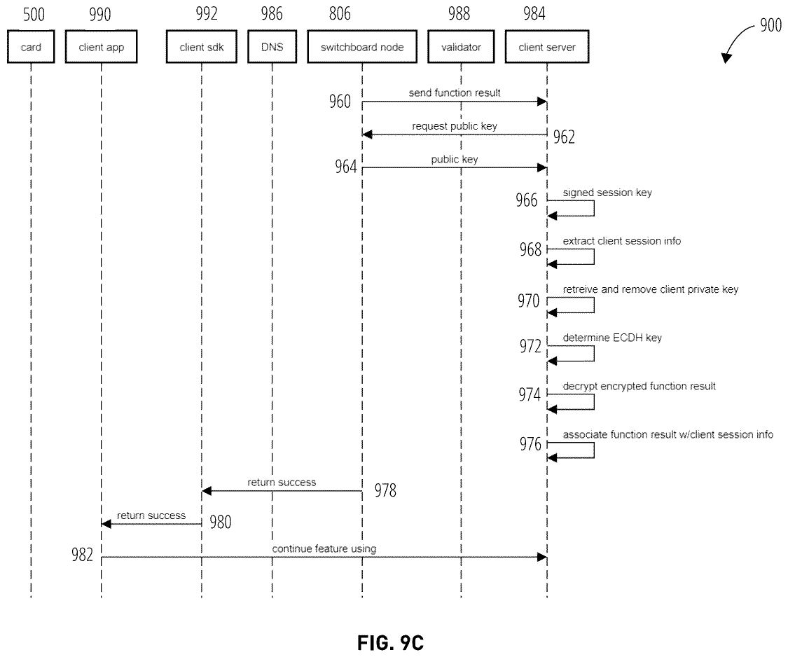

The node 806 may authorize or authenticate the client SDK 838 or user, and the node 806 may utilize the additional components, such as the session and node generator 808, and message router 810, to perform the operation, as discussed in FIG. 9A-FIG. 9C. Note the validation system 826 never interact with the merchant systems merchant system 824, nor vice versa. The nodes 806 broker all communication.

In embodiments, the switchboard system 802 may utilize a hyperledger fabric 822 to manage synchronizing the shared operation data 814 and member management across the network. The hyperledger fabric 822 is distributed ledger framework having a permissioned network model that only authorized participants can join the network and access the data that is stored on a ledger.

In embodiments, the hyperledger fabric 822 may be generated by creating one or more set of peers, an ordering service, and a channel. Once the network is created, the system 800 deploys chaincode to the network or nodes 806 permitted to access the fabric. The chaincode is the code that runs on the blockchain and executes the network control 828 and operation data 814 logic code. Once the chaincode is deployed, each of the nodes 806 is configured to invoke transactions on the blockchain to add data to the blockchain, e.g., the operational data. A node 806 or another device can query the ledger to retrieve data. The ledger is a distributed database that stores all of the data that has been added to the blockchain.

All nodes 806 keep an independently verifiable log of their actions that can be transmitted to a centralized aggregator to build a picture of overall network usage. At a central level, system 800 can manage network operation data and management and have a centralized view of network use, aggregated and abstracted to the appropriate level.

FIG. 9A-FIG. 9C illustrate an example sequence 900 to perform operations between a contactless card and services provided by a card issuer and/or merchant. Steps described in FIG. 9A-FIG. 9C illustrate an example process for exchanging the FIDO challenge and response from the contactless card 102. The illustrated sequence 900 includes actions and communications performed by a contactless card 102, a client SDK 992 including a client app and a client SDK 992, a Domain Name System DNS 986, a switchboard system node 806, a partner services validator 988 including a merchant and/or validator, and control services client server 984 including a client server or system.

In embodiments, at 902 the client SDK 992 including the client app may send a request and establish a session with a client server 984 such that a result may be associated with the correct client device or user. The request establishes a relationship between the client device and client server, which may be an issuer server. At 904, the client server 984 generates a session and CLIENT SESSION INFORMATION. At 906, the client server 984 returns the session information, e.g., the CLIENT SESSION INFORMATION. In embodiments, the CLIENT SESSION INFORMATION may be the Client implementation-specific user session identification information.

At 908, the client SDK 992 may initiate a contactless card authentication process with the client SDK 992. For example, the client SDK 992 may call a function and/or pass information to the client SDK 992 to initiate authentication via a contactless card. At 910-914, the client may utilize DNS to identify a node and establish communication with the node. Specifically, at 910, the client SDK 992 may send a request for switchboard hostnames, and at 912 the DNS 986 may return information including one or more hostnames. At 914, the client SDK 992 may determine a switchboard node 806 to communicate.

At 916, the client SDK 992 may send a request for a session to the switchboard system node 806. In embodiments, the request for a session may be for a function request in the format <FUNCTION REQUEST>. In embodiments, the FUNCTION REQUEST may be the data/function that the client would like to request once a contactless card has been validated. The function could be for any service discussed herein, e.g., authenticate the user, perform a transaction, request autofill data, etc. At 918, switchboard system node 806 may generate a nonce and a signed session token. The signed session token may be a JSON Web Token (JWT). When generating the JWT, the following elements should be set:
iss: The unique ID of the current node,
nonce: An 8 hex character, randomly generated nonce,
exp: The expiration timestamp (+5 minutes),
client_id: The requesting client's Client ID,
sub: The requesting client's Device Fingerprint,
sid: Arbitrary session info sent from client,
scope: The function being requested to be performed.

The nonce may be unique, random bytes generated to ensure the unrepeatability of a message with a contactless card. The nonce is critical to the security and operation of switchboard system node 806. The nonce validity is tracked by tying it to a session which can be validated by any member of the platform. As mentioned, sessions are JSON Web Tokens signed using a node-specific private key issued by the network. These JWTs are verifiable by a system with the corresponding public key, which they can also verify by confirming it was issued by us or an approved delegate. The signed session token is a JWT generated token to establish validity and expiration of the nonce and to associate the contactless card tap to the current client session. In example, the signed session token includes <NONCE>, <CLIENT SESSION INFO>, and <FUNCTION REQUEST> signed with <NODE PRIVATE KEY>, where the NODE PRIVATE KEY is the switchboard system node 806 private key. The switchboard system node 806 may include a NODE PUBLIC/PRIVATE KEY, which are a keypair used to sign and validate JWTs.

At 920, the switchboard system node 806 may return session information to the client SDK 992. The session information may include the signed session token (<SIGNED SESSION TOKEN>), the NONCE <NONCE>, the function terms of service <FUNCTION TOS>, and the terms of service version <TOS VERSION>. The FUNCTION TOS may be the terms of service that the user must consent to in order to allow the client to execute the requested function, and the TOS VERSION may be the version of the terms of service. At 922, the client SDK 992 may determine and/or receive user consent to the terms of service. In one example, the client SDK 992 captures and records the user consent to <FUNCTION TOS> on <CONSENT DATE> with <TOS VERSION>. The CONSENT DATE may be the timestamp for the user's consent to the TOS.

At 924, the client SDK 992 exchanges one or more messages with a contactless card. In one example, the exchange may be based on the contactless card being tapped to a client device. In embodiments, the client SDK 992 may provision data to the contactless card 102 to use during the session to perform the function. The data may be provided to the contactless card 102 in an NDEF message. In one example, the data is written to the card in NDEF format using an update binary command. The data may include a NONCE to provide a level of security that the message received from the card is part of the same session. Additionally, the data may include additional information, such as one or more control bits to control the format generated by the contactless card. Table 2 below illustrates an NDEF message format example.

TABLE 2

| Byte | Data Item | Value |
|---|---|---|
| 00 | NDEF Message | D1 (only record) |
| | Tag | |
| 01 | Length of Record | 01 |
| | Type | |
| 02 | Length of Record | 33 |
| 03 | text record type | 54 |
| 04 | Length of | 02 |
| | Language | |
| 05-06 | Language | 65 6E (“en”) |
| 07 . . . | NONCE | 8 bytes of ASCII HEX encoded 4 bytes |
| 0E | | binary data |
| 0F . . . | Session | 4 bytes of ASCII HEX encoded 2 bytes |
| 12 | Indicators | binary data |
| 13 . . . | Control | 4 bytes of ASCII HEX encoded 2 bytes |
| 16 | Indicators | binary data |
| 17 . . . | Update Date | 16 bytes of ASCII HEX encoded 8 bytes |
| 26 | creation Time | binary data - represents 64 bit unix |
| | | timestamp |
| 27 . . . | Update MAC | MAC to protect control indicators - 16 bytes |
| 36 | | of ASCII HEX encoded 8 bytes binary data |

In embodiments, the updated MAC may be calculated to protect the control indicators. Specifically, The MAC M is determined by calculating a MAC over the 10 bytes of the update data U with the Update MAC Card Key (MCK) as follows:

U=[Control Indicators (2 bytes)∥Update Date Time (8 bytes)∥‘80’∥‘00 00 00 00 00’]

Consider U as two blocks of 8 bytes of data: U=U1∥U2
Compute B=DES (MCKL) [U1]
Compute B=[B XOR U2]
Compute B=DES (MCKL) [B]
Compute B=DES-1 (MCKR) [B]

Finally, the MAC M=DES (MCKL) [B]

At 924, the contactless card may generate and provide a message to the client device including the client SDK 992. The data in the message may be utilized by the system discussed herein to perform the function requested. One example of the message is illustrated and discussed in FIG. 10, message 1000.

At 926, the client including the client SDK 992 may send a message and information to the switchboard system node 806. The message may be the message received from the contactless card 102, e.g., message 1000. In addition, the client SDK 992 may send the consent date, the TOS version, and the signed session token to the switchboard system node 806. The switchboard system node 806 may utilize the information to ensure that the session is valid. At 928, the switchboard system node 806 verifies the signed session is valid, e.g., is the previously provided signed session token.

In some embodiments, the switchboard system node 806 is configured to determine which issuer system or client server it should route the message to for processing. At 930, the switchboard system node 806 may determine the issuer ID by extracting it from the message received from the contactless card 102 via the client SDK 992. As mentioned, the issuer ID identifies the issuer of the contactless card 102.

In embodiments, the switchboard system node 806 is configured to generate and communicate secure communications with the issuer system, e.g., the client server 984 and the validator 988. At 932, the switchboard system node 806 sends a request for a key to the client server 984. The key may be utilized to perform the secure communications. In one example, the key request may be an elliptical curve Diffie-Hellman (ECDH) key request. Embodiments are not limited in this manner and alternative key protocols may be utilized, e.g., Supersingular isogeny Diffie-Hellman key exchange (SIDH or SIKE).

At 934, the client server 984 generates a portion of the key. In some instances, the client server 984 may generate half of the ECDH key for encryption/decryption of PII. Specifically, the client server 984 may generate <CLIENT EC PUBLIC KEY> and <CLIENT EC PRIVATE KEY> using Elliptic Curve P256. The CLIENT EC PUBLIC KEY AND CLIENT EC PRIVATE KEY is the first half of the ECDH key negotiation.

At 936, the client server 984 stores the generated portion of the key in a storage. Specifically, the client server 984 may store <CLIENT EC PUBLIC KEY> and <CLIENT EC PRIVATE KEY> with <KEY ID>, where the KEY ID is used by the Client Server to cache its short-lived EC public/private key for later ECDH key completion. In one example, the key may be stored in a secure memory location and may be used to when PII is received for the session.

In embodiments, the client server 984 may return the public key portion to the switchboard system node 806 with the KEY ID at 938. The switchboard system node 806 may store the public key portion with the KEY ID for later use. At 940, the switchboard system node 806 may request a validation to be performed by the validator 988. In one example, the switchboard system node 806 may send a request validation as Request validation <MESSAGE>, <SIGNED SESSION TOKEN>, <CLIENT EC PUBLIC KEY>, <CONSENT DATE>, and the <TOS VERSION>. The validator 988 may make an out-of-band request back to the switchboard system node 806 for the public key to verify the session at 942. At 944, the switchboard system node 806 may provide the node's public key, i.e., <NODE PUBLIC KEY>. Further and at 946, the validator 988 may utilize the node's public key to verify the secure session token.

In embodiments, the validator 988 may validate the message at 948. In embodiments, the validator 988 may perform a number of validations including ensure the nonce in the message is correct along with additional information, such as the card's unique identifier (pUID), and the counter value (pATC).

At 950, the validator 988 may store information associated with the session. For example, validator 988 may store the <CONSENT DATE> with the <TOS VERSION> and the <PUID>. The validator 988 may also generate another portion of the key, e.g., the ECDH key. For example, the 988 may Generate <ISSUER EC PUBLIC KEY> and <ISSUER EC PRIVATE KEY> using Elliptic Curve P256. The ISSUER EC PUBLIC KEY and ISSUER EC PRIVATE KEY may be the second half of the ECDH key negotiation.

At 954, the validator 988 may generate the complete ECDH key. For example, the validator 988 generate the <ECDH KEY> from <ISSUER EC PRIVATE KEY> and <CLIENT EC PUBLIC KEY>. The ECDH KEY is the final key generated using ECDH key negotiation.

The validator 988 may utilize the ECDH KEY to encrypt data for the function. For example, and in some instances, if the validator 988 validates the message, the validator 988 may execute a function request to create a function result and encrypts the result with the ECDH KEY at 956. For example, the validator 988 may Execute <FUNCTION REQUEST> to create <FUNCTION RESULT> and encrypt it with the <ECDH KEY>. The function result may be any result based on the requested function, e.g., verification of the card.

At 958, the validator 988 may return the function result to the switchboard system node 806. In some instances, the function result is returned encrypted. For example, the validator 988 may return the <ENCRYPTED FUNCTION RESULT> and the <ISSUER EC PUBLIC KEY>.

In embodiments, at 960 the switchboard system node 806 sends the function result to the client server 984 to process the result. In one example, the switchboard system node 806 may send the <ENCRYPTED FUNCTION RESULT>, <KEY ID>, <ISSUER EC PUBLIC KEY>, and <SIGNED SESSION TOKEN>. At 962 and 964, the client server 984 may make a request for and receive the public key from the switchboard system node 806. In some instances, the exchange may be performed via out-of-band communication channels. The public key for the node may be <NODE PUBLIC KEY>. The public key may be used to verify the sender of the function result, etc. At 966, the client server 984 may verify the signed session key with the node's public key <NODE PUBLIC KEY> to verify the sender of the information. At 968, the client server 984 may extract client information from the signed session token. For example, the client server 984 may Extract <CLIENT SESSION INFO> from <SIGNED SESSION TOKEN>, i.e., extracting the client implementation-specific user session identification information.

Further and at 970, the client server 984 may retrieve the client private key with the KEY ID. Specifically, the client server 984 may get and remove the <CLIENT PRIVATE KEY> from cache using the <KEY ID>. At 972, the client server 984 may generate or compute the ECDH key. For example, the client server 984 may compute the <ECDH KEY> with the <CLIENT PRIVATE KEY>+<ISSUER EC PUBLIC KEY>. The client server 984 may decrypt the function result with the computed key at 974. Specifically, the client server 984 may decrypt the <ENCRYPTED FUNCTION RESULT> with the <ECDH KEY> to determine the <FUNCTION RESULT>. At 976, the client server 984 associates the function result with the session.

In embodiments, the switchboard system node 806 may return that the function result was successfully completed or not at 978 to the client SDK 992. Further and at 980, the client SDK 992 may notify the client app 990 of the result. At 982, the client app 990 may utilize the feature. For example, the client server 984 may communicate with the client server 984 to continue feature using with the <CLIENT SESSION INFO> to fetch the redacted <FUNCTION RESULT>.

FIG. 10 illustrates an example of a message 1000 that may be communicated by a contactless card 102 to perform the functions described herein. One or more of the fields in message 1000 may also be utilized to route the message 1000 through the switchboard system of FIG. 8 and perform authentication/validation techniques.

In embodiments, the message 1000 includes an applet version 1002 field, an issuer discretionary indicator 1004 field, an Issuer Identifier 1006 field, a pKey ID 1008 field, a pUID 1010 field, a pATC 1012 field, a nonce 1014 field, and an encrypted cryptogram 1016. The encrypted cryptogram 1016 can include the FIDO response discussed above.

In embodiments, the fields may be in plain text or encrypted. For example, the applet version 1002 field may include an applet version in plain text. The applet version indicate which applet version is installed on a contactless card 102 and may be used by the other systems to determine how to process the message 1000 when communicated. For example, different Applet versions require different validation logic, e.g., an older message may be routed through an issuer system to perform various operations for validation, while a newer message may be routed through the switchboard system to perform the various operations including validation.

In embodiments, the message 1000 includes an issuer discretionary indicator 1004 field that may include issuer data and set at the time of personalization. In addition, the message 1000 includes an Issuer Identifier 1006 field that may include a unique ID assigned to the entity issuing the card, e.g., the issuer. For example, each issuer may be assigned a unique identifier during an onboarding operation when joining the system. The issuer ID can be used by the switchboard system 1308 to route a message and its contents to the appropriate services that are associated with that particular issuer.

In embodiments, the message 1000 includes a pKey ID 1008 field. In some instances, pKey ID 1008 field may include data that identifies a set of master keys, e.g., a card's master keys, to use to validate the message. Each card may have its own set of master keys that may be generated during the personalization of the card. The master keys may be utilized to generate session keys that are used to generate the application cryptogram. The keys may be shared with the issuer system and/or the switchboard system when the card is generated and later used by a system to perform operations, such as validation.

In embodiments, each contactless card 102 is given a unique 16 decimal digit identity (pUID) at time of personalization. Derivation of card applet's unique keys using the pUID are performed off-card. The resultant Application Keys are injected during personalization of the card. The process for deriving the Application Keys is as follows:
Create a number of Issuer Master Keys sets and assign each a unique three-byte Key ID (6 hexadecimal digits).
For each card Application:
   Assign a Key ID to each pUID.
   Use the Key ID to identify the Issuer Master Keys for the Cryptogram calculation and Data Encipherment.
   Create Diversification data as follows:
      Create a 16-digit quantity X from the 16 digits of the pUID.
      Each application key is formed by the following steps:
         Compute ZL by encrypting X using the appropriate Issuer Master Key identifier;
         Compute ZR by XOR'ing X with FFFFFFFFFFFFFFFF and then encrypting the result using the Issuer Master Key;
         Concatenate ZL with ZR to form the Application Key.

The message 1000 may include a pUID 1010 field including a card unique identifier assigned to the contactless card at personalization time. The pUID 1010 field data may be a combination of alphanumeric characters used to uniquely identify each card and associated with a user.

In embodiments, the message 1000 includes a pATC 1012 field configured to hold a counter value. The counter value keeps a count of reads (taps) made on the contactless card in a hexadecimal format in one example. Further, a counter value may be used to generate session keys to encrypt at least a portion of a message.

In embodiments, each time a message 1000 is created a new session key is derived and utilized to generate one or more portions of the message 1000. Specifically, a session key is used to calculate the cryptographic MAC (Application Cryptogram).

The card's applet supports an improved variation of the session key derivation option as per EMV 4.3 book 2 annex A1.3.1 to generate a unique cryptogram session key ASK as follows:
Compute SKL by encrypting [ATC[2]∥ATC[3]∥‘F0’∥‘00’∥[ATC[0]∥[ATC[1]∥[ATC[2]∥[ATC[3] with the Application Key
Compute SKR by encrypting [ATC[2]∥ATC[3]∥‘0F’∥‘00’∥[ATC[0]∥[ATC[1]∥[ATC[2]∥[ATC[3]] with the Application Key
Concatenate SKL with SKR to form the Authentication Session Key.

An Authentication Session Key is used to encrypt the cryptographic MAC.

The card applet also supports the improved variation of the session key derivation option as per EMV 4.3 book 2 Annex A1.3.1 to generate a unique encipherment session key DESK as follows:
Compute SKL by encrypting [ATC[2]∥ATC[3]∥‘F0’∥‘00’∥‘00’∥‘00’∥‘00’∥‘00’] with the Data Encryption Key
Compute SKR by encrypting [ATC[2]∥ATC[3]∥‘0F’∥‘00’∥‘00’∥‘00’∥‘00’∥‘00’] with the Data Encryption Key
Concatenate SKL with SKR to form the Data Encipherment Session Key.

The cryptogram C is determined by calculating a MAC over the 32-byte transaction data T using the Authentication Session Key (ASK) as follows:
T=[pVersion (2 bytes)∥pIssuerID (3 bytes)∥pKeyID (3 bytes)∥pUID (8 bytes)∥pATC (4 bytes)∥nonce (4 bytes)∥pSHSEC (4 bytes)∥‘80’∥‘00 00 00’]

Consider T as four blocks of 8 bytes of data: T=T1∥T2∥T3∥T4
Compute B=DES (ASKL) [T1]
Compute B=[B XOR T2]
Compute B=DES (ASKL) [B]
Compute B=[B XOR T3]
Compute B=DES (ASKL) [B]
Compute B=[B XOR T4]
Compute B=DES (ASKL) [B]
Compute B=DES-1 (ASKR) [B]

Finally, the cryptogram C=DES (ASKL) [B]

The cryptogram encipherment is performed with the Data Encipherment Session Key (DESK) being used to encrypt in Cipher Block Chaining mode (CBC) as follows:
Generate an 8-byte random number [RND]
Compute E1=DES3 (DESK) [RND]
Compute B=[E1] XOR [C]
Compute E2=DES3 (DESK) [B]
Finally, the 16-byte enciphered payload E=[E1]∥[E2]

To recover using decryption mode:

$$RND = DES 3 - 1 ( DESK ) [ E 1 ]$$

$$B = DES 3 - 1 ( DESK ) [ E 2 ]$$

$$C = [ E 1 ] XOR [ B ]$$

In embodiments, a portion of the data provided in message 1000 is static and set on the card during the personalization of the card and other data is dynamic and may be generated by the card during an operation, e.g., when a read operation is being performed. Note that in some instances, the static information may be updateable, but may require the customer and card to go through a secure update process, which may be controlled by the issuer.

In embodiments, the contactless card 102 may communicate a message between a device, such a mobile device, during a read operation. For example, in response to the contactless card 102 being tapped onto a surface of the device, e.g., brought within wireless communication range, a read operation may be performed on the contactless card 102, and the contactless card 102 may generate and provide the message to the device. For example, once within range, the contactless card 102 and the device may perform one or more exchanges for the contactless card 102 to send the message to the device. FIG. 9A, step 924 illustrates one example of an exchange.

The wireless communication may be in accordance with a wireless protocol, such as near-field communication (NFC), Bluetooth, wireless fidelity (Wi-Fi), and the like. In some instances, a message may be communicated between a contactless card 102 and a device via wired means, e.g., via the contact pad 504, and in accordance with the EMV protocol.

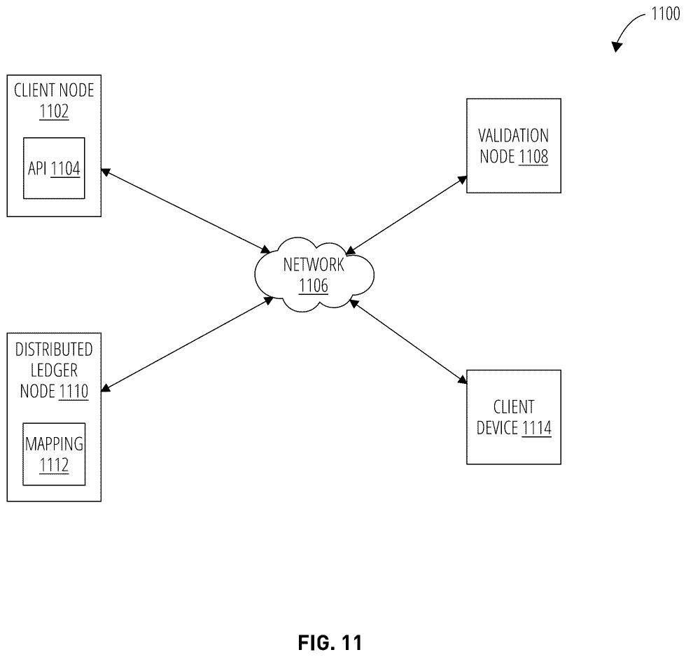

FIG. 11 illustrates a distributed network authentication system 1100 according to an example embodiment. As further discussed below, system 1100 can include client node 1102, API 1104, network 1106, distributed ledger node 1110, mapping 1112, and client device 1114. Although FIG. 11 illustrates single instances of the components, system 1100 can include any number of components. The distributed network authentication system 1100 described in FIG. 11 can be used by the connection network 100 in FIG. 1 and connection network 400 in FIG. 4, discussed above to validate the FIDO responses sent in each example embodiment described above.

System 1100 can include a client node 1102, which can be a network-enabled computer as described herein. In some examples, client node 1102 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1100.

In some examples, client node 1102 can execute one or more applications, such as software applications, that enable, for example, network communications with one or more components of system 1100, transmit and/or receive data, and perform the functions and processes described herein.

The client node can contain an API 1104. For example, various different APIs can be provided for an application (e.g., executed on a computing device, such as a network-enabled computer) that can interact with a service. For example, an application executed on a device (e.g., a smart phone, smart watch, tablet, laptop, or other device) call interact with a web-based service by calling the API 1104 to interact with the service, such as by performing a remote call to an API for interacting with a web-based service.

API 1104 can be provided in the form of a library that includes specifications for routines, data structures, object classes, and variables. In some cases, such as for representational state transfer (REST) services, an API (e.g., a REST API or RESTful API, or an API that embodies some RESTful practices) is a specification of remote calls exposed to the API consumers (e.g., applications executed on a client computing device can be consumers of a REST API by performing remote calls to the REST API). REST services generally refer to a software architecture for coordinating components, connectors, and/or other elements, within a distributed system (e.g., a distributed hypermedia system).

Client node 1102 can communicate with one or more other components of system 1100 either directly or via network 1106. Network 1106 can comprise one or more of a wireless network, a wired network or any combination of wireless network and wired network and may be configured to connect the components of system 1100. While FIG. 10 illustrates communication between the components of system 1100 through network 1106, it is understood that any component of system 1100 can communicate directly with another component of system 1100, e.g., without involving network 1106.

System 1100 can include a validation node 1108, which can be a network-enabled computer as described herein. In some examples, validation node 1108 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1100.

In some examples, validation node 1108 can execute one or more applications, such as software applications, that enable, for example, network communications with one or more components of system 1100, transmit and/or receive data, and perform the functions and processes described herein.

In some examples, each validation node can be associated with a routing number, and the routing number identifies the entity controlling the keys for the authentication namespace. The authentication namespace can be related to one or more of a particular entity, a particular set of cards, or a particular set of security keys (e.g., master keys, diversified keys, session keys) associated with an entity, a set of cards, or a type of cards.

System 1100 can include a distributed ledger node 1110, which can be a network-enabled computer as described herein. In some examples, distributed ledger node 1110 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1100.

In some examples, distributed ledger node 1110 can execute one or more applications, such as software applications, that enable, for example, network communications with one or more components of system 1100, transmit and/or receive data, and perform the functions and processes described herein.

Distributed ledger node 1110 can containing a mapping 1112. In some examples, mapping 1112 can be in the form of one or more databases. Exemplary databases can include, without limitation, relational databases, non-relational databases, hierarchical databases, object-oriented databases, network databases, and any combination thereof. The one or more databases can be centralized or distributed. The one or more databases can be hosted internally by any component of system 1100, or the one or more databases can be hosted externally to any component of the system 1100. In some examples, the one or more databases can be contained in the distributed ledger node 1110, and in other examples the one or more databases can be stored outside of distributed edger distributed ledger node 1110 but in data communication with distributed ledger node 1110. The one or more databases can be implemented in a database programming language. Exemplary database programming languages include, without limitation, Structured Query Language (SQL), MySQL, HyperText Markup Language, JavaScript, Hypertext Preprocessor Language, Practical Extraction and Report Language, Extensible Markup Language, and Common Gateway Interface. Queries made to the one or more databases can be implemented in the same database programming language used to implement the one or more databases. For example, if the one or more databases are an SQL database, then queries made to the database can be made in SQL (e.g., SELECT column1, column2 FROM table1, table2 WHERE column2=‘value’;). It is understood that the one or more databases can be implemented in any database programming language and that the programming implementation of the query can be adjusted as necessary for compatibility with the one or more databases and to reflect the particular information to be queried.

In some examples, the one or more databases can be contained within distributed ledger node 1110. In other examples, the one or more databases can be remote from distributed ledger node 1110 but in data communication with distributed ledger node 1110. Data communication between the one or more databases and distributed ledger node 1110 can be a direct data communication or data communication via a network, such as the network 1106.

In some examples, client node 1102 can be in data communication with distributed ledger node 1110. Distributed ledger node 1110 can contain mapping 1112. Mapping 1112 may include, e.g., a mapping between a validation node address and the validation node 1108, a mapping between a routing number and a validation node address, and/or a mapping between a routing number and validation node 1108. In some examples, mapping 1112 can include a digital signature associated with an entity having permission to validate for a routing number. Based on one or more of these associations, client node 1102 can call validation node for validation and/or provide direction to the client device to reach the appropriate validation node. This can be accomplished by calling a validation API associated with validation node 1108.

In some examples, iterations of the mappings described herein, such as mapping 1112, can also include a software or applet version number. The version number can be used to identify a validation node or validation node address or choose between multiple validation addresses for one validation node.

In some examples, client node 1102 and distributed ledger node 1110 can be permissioned (e.g., allowed to join a network) with the aid of a certificate and/or a cryptographic authentication mechanism (e.g., a non-fungible token). The certificate and/or a cryptographic authentication mechanism may be issued by, e.g., a consortium authority or other administrative entity associated with the distributed network. If granted appropriate permissions, distributed ledger node 1110 can update mapping 1112 to reflect a different association between, e.g., a routing number, a validation node address, and a validation node. In some examples, degrees of permissions can be issued. For example, if client node 1102 were to function to route data to validation node 1108 (or other validation nodes), client node 1102 can be given a certain level of permissions. As another example, if distributed ledger node 1110 were to have the capability to update mapping 1112, distributed ledger node 1110 can have a different, higher level of permissions.

System 1100 can include a client device 1114, which can be a network-enabled computer as described herein. In some examples, distributed ledger node client device 1114 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1100. Client device 1114 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. In some examples, client device 1114 can be in data communication with another network-enabled computer not shown in FIG. 11, such as a smart card (e.g., a contactless card or a contact-based card).

In some examples, client device 1114 can execute one or more applications, such as software applications, that enable, for example, network communications with one or more components of system 1100, transmit and/or receive data, and perform the functions and processes described herein.

In some examples, upon receipt of an authentication request, client device 1114 can call (e.g., via an API) client node 1102. The call can include a routing number and/or an applet or software version number, and client node 1102 can query distributed ledger node 1110 and mapping 1112. Once the query returns the identification of a validation node (e.g., validation node 1108) and/or a validation node address associated with that routing number and/or applet or software version, client node 1002 can reply to client device 1114. Client device 1114 can then proceed with authentication with the validation node. The authentication can be performed by, e.g., the systems and methods described herein, such as by the generation, encryption, transmission, decryption, and validation of a cryptogram as described herein.

In some examples, client node 1102 can be co-resident with validation node 1108. In these examples, client node 1102 can handle the authentication in a single call from client device 1114. In some examples, this can be acceptable only if it is permissible for the full authentication transmission (e.g., a cryptogram as described herein) to be sent to client nodes that are not involved in authentication.

In some examples, if client node 1102 receives, from client device 1114, a routing number that is not handled by its location, client node 1102 can return a code indicating that this routing number is not handled, along with validation node address for the responsible validation node. Client device 1114 can then send the full authentication transmission to validation node 1108 using the received validation node address.

In some examples, client node 1102 can enter the distributed network with different permissions. For example, client node 1102 can be a read-only router of data. As another example, client node 1102 can have permission to send messages to distributed ledger node 1110 updating one or more routing paths for one or more routing numbers. However, client node 1102 would be prevented from updating one or more routing paths for one or more routing numbers for other entities that control other routing numbers which are not associated with client node 1102 or that did not grant this permission. As another example, distributed ledger node 1110 can contain contracts and/or records that can validate the permission of a specific entity to change a specific routing record based on its digital signature. As another example, the consortium authority or other administrative entity controlling the distributed network can have additional privileges to, without limitation, add new members (e.g., client nodes, distributed ledger nodes, validation nodes, and/or client devices), add new signature credentials, add new keys, add new certifications, and to revoke any of the foregoing. In some examples, the foregoing permissions can be delegated to client node 1102, distributed ledger node 1110, and/or validation node 1108, if security, legal, and/or financial conditions are met, however, delegation is not required.

In some examples, one or more APIs can facilitate communication between components of system 1100 via network 1106. In other examples, one or more APIs are not required. Rather, the components of system 1100 could be in direct communication and/or dedicated to one or more specified entities, to allow the specified entities to keep data from being transferred to, transferred from, or transferred via, non-specified entities. This may further promote data security and avoid detection of data traffic patterns by non-specified entities.

In some examples, entities could establish a standard for nodes having APIs based on the intended function of those nodes. For example, a first standard could be established for data routing nodes and a second standard could established for nodes performing mapping and/or authentication functions. As another example, a routing API, a mapping API, and a validation API can be established, which can allow for the same device or hardware configuration to perform these functions. However, the use of keys, including secret keys by validation node 1108 for authentication, can require storage of the keys in one or more HSMs, to promote key security and ensure that the keys are never entered into memory.

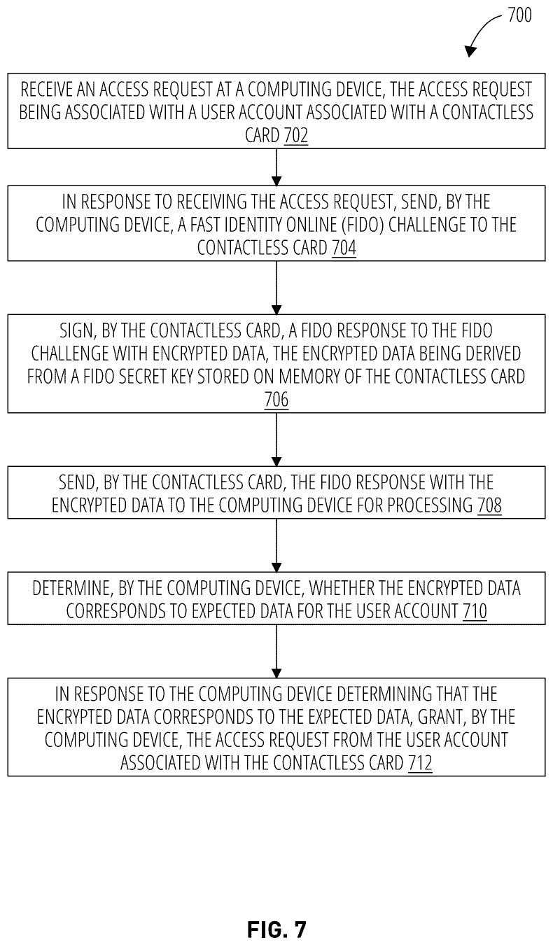

The various elements of the devices as previously described with reference to FIGS. 1-11 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a non-transitory machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. A method, comprising:
receiving an access request at a computing device, the access request being associated with a user account associated with a contactless card;
in response to receiving the access request, sending, by the computing device, a Fast Identity Online (FIDO) challenge to the contactless card;
signing, by the contactless card, a FIDO response to the FIDO challenge with encrypted data, the encrypted data being derived from a FIDO secret key stored on memory of the contactless card;
sending, by the contactless card, the FIDO response with the encrypted data to the computing device for processing;
determining, by the computing device, whether the encrypted data corresponds to expected data for the user account; and
in response to the computing device determining that the encrypted data corresponds to the expected data, granting, by the computing device, the access request from the user account associated with the contactless card.

2. The method of claim 1, further comprising receiving the access request from the user account at a transaction server as the user account attempts to access features of the transaction server; and
wherein granting the access request by the computing device comprises the computing device sending the transaction server a message indicating that the user account is authorized to access the features of the transaction server based on the encrypted data corresponding to the expected data.

3. The method of claim 1, further comprising personalizing a FIDO authenticator application on the contactless card with the FIDO secret key, wherein personalizing the FIDO authenticator application is performed during a contactless card personalization process.

4. The method of claim 1, wherein the FIDO secret key is:
derived by an issuer server based on a master key controlled by the issuer server;
a randomly generated number by the issuer server; or
derived or generated by a FIDO authenticator application operating on the contactless card.

5. The method of claim 1, wherein the computing device determining that the encrypted data corresponds to the expected data comprises:
the computing device decrypting the encrypted data to obtain decrypted data; and
evaluating the decrypted data to ensure that it corresponds to the expected data.

6. The method of claim 5, further comprising:
associating a FIDO public key with the user account and the contactless card, wherein the FIDO public key is retained by a server associated with an issuer of the contactless card at the contactless card personalization process; and
transmitting the FIDO public key to the computing device.

7. The method of claim 6, wherein decrypting the encrypted data to obtain the decrypted data comprises the computing device using the FIDO public key to decrypt the encrypted data to obtain the decrypted data;
wherein evaluating the decrypted data comprises comparing the decrypted data to the expected data, the expected data including or being derived from the FIDO secret key, to determine whether the decrypted data corresponds to the expected data; and
wherein the method further comprises, in response to the decrypted data corresponding to the expected data, sending, by the computing device, instructions to another computing device that also received the access request to grant the access request from the user account associated with the contactless card.

8. The method of claim 1, wherein the computing device receives a second access request associated with the user account, and the method further comprises:
in response to receiving the second access request, sending, by the computing device, a second FIDO challenge to the contactless card;
deriving, by the contactless card, second encrypted data from an altered version of the FIDO secret key, the second encrypted data being different than the encrypted data;
signing, by the contactless card, a second FIDO response to the second FIDO challenge with the second encrypted data;
sending, by the contactless card, the second FIDO response with the second encrypted data to the computing device for processing; and
in response to the computing device determining that the second encrypted data corresponds to altered expected data that is altered based on the altered version of the FIDO secret key, granting, by the computing device, the second access request from the user account associated with the contactless card.

9. The method of claim 1, wherein the access request includes at least one selected from the group of:
a request by the user to sign into the user account;
a request by the user to sign into another user account; and
a transaction request.

10. A contactless card, comprising:
a memory to store executable instructions thereon; and
a processing circuit to execute the executable instructions, which when executed by the processing circuit causes the processing circuit to:
send an access request to an authentication server, the access request being associated with a user account associated with the contactless card;
receive, from the authentication server, a Fast Identity Online (FIDO) challenge;
sign a FIDO response to the FIDO challenge with encrypted data, the encrypted data being derived from a FIDO secret key stored on the memory of the contactless card;
send the FIDO response with the encrypted data to the authentication server for processing;
receive an indication that the authentication server has determined that the encrypted data correspond to expected data for the user account; and
in response to receiving the indication, process the access request with an application server in communication with the contactless card.

11. The contactless card of claim 10, wherein the processing circuit is further to:
send the access request to the application server for forwarding to the authentication server, the access request including a request to access features of the application server; and
in response to receiving the indication, access the features of the application server.

12. The contactless card of claim 10, wherein the contactless card includes a FIDO authenticator application on the contactless card with the FIDO secret key, wherein the FIDO authenticator application was installed on the contactless card with the FIDO secret key during a contactless card personalization process; or
wherein the contactless card includes a FIDO authenticator application on the contactless card and the FIDO secret key is derived by the FIDO authenticator application from another source or generated by the FIDO authenticator application as a random number.

13. The contactless card of claim 10, wherein the processing circuit is further to:
send a second access request, associated with the user account, to the authentication server;
receive, from the authentication server, a second FIDO challenge corresponding to the second access request;
derive second encrypted data from an altered version of the FIDO secret key, the second encrypted data being different than the encrypted data;
sign a second FIDO response to the second FIDO challenge with the second encrypted data; and
send the second FIDO response with the second encrypted data to the authentication server for processing.

14. The contactless card for claim 13, wherein the processing circuit is further to
receive a second indication that the authentication server has determined that the second encrypted data corresponds to altered expected data that is altered based on the altered version of the FIDO secret key; and
in response to receiving the second indication, process the second access request with the application server in communication with the contactless card.

15. The contactless card of claim 10, wherein the access request includes at least one selected from the group of:
a request by the user to sign into the user account;
a request by the user to sign into another user account; and
a transaction request.

16. An authentication server, comprising:
a memory to store executable instructions thereon;
a processing circuit to execute the instructions, which when executed cause the processing circuit to:
receive an access request from a transaction server in communication with a contactless card associated with a user account, wherein the authentication server is also in communication with the contactless card;
in response to receiving the access request, send a Fast Identity Online (FIDO) challenge to the contactless card;
receive, from the contactless card, a FIDO response to the FIDO challenge, the FIDO response being signed by the contactless card with encrypted data derived from a FIDO secret key stored on memory of the contactless card;
determine whether the encrypted data corresponds to expected data for the user account; and
in response to the encrypted data corresponding to the expected data, grant the access request from the user account associated with the contactless card.

17. The authentication server of claim 16, wherein the transaction server is to receive the access request from the user account as the user account attempts to access features of the transaction server; and
wherein the processing circuit to grant the access request includes the processing circuit to send the transaction server a message indicating that the user account is authorized to access the features of the transaction server based on the encrypted data corresponding to the expected data.

18. The authentication server of claim 16, wherein, to determine that the encrypted data corresponds to the expected data, the processing circuit is further to:
decrypt the encrypted data to obtain decrypted data; and
evaluate the decrypted data to ensure that it corresponds to the expected data.

19. The authentication server of claim 18, wherein the processing circuit is further to receive, from a server of an issuer of the contactless card, a FIDO public key associated with the user account and the contactless card.

20. The authentication server of claim 19, wherein, to decrypt the encrypted data to obtain the decrypted data, the processing circuit is further to use the FIDO public key to decrypt the encrypted data to obtain the decrypted data;
wherein to evaluate the decrypted data, the processing circuit is further to compare the decrypted data to the expected data, the expected data being or derived from the FIDO secret key; and
wherein, in response to the decrypted data corresponding to the expected data, the processing circuit is further to send instructions to a transaction server, that initially received the access request to access features of the transaction server, to grant the access request from the user account associated with the contactless card.
